(19) United States
(12) Patent Application Publication
(10) Pub. No.: US 2009/0055929 A1
(43) Pub. Date: Feb. 26, 2009

(54) Local Domain Name Service System and Method for Providing Service Using Domain Name Service System

(75) Inventors: Pan Jung Lee, Seoul (KR); Jeen Hyun Bae, Seoul (KR); Suk Moon Lee, Seoul (KR); Jong Ho Won, Incheon (KR)

Correspondence Address: THE WEBB LAW FIRM, P.C., 700 KOPPERS BUILDING, 436 SEVENTH AVENUE, PITTSBURGH, PA, 15219, US

(73) Assignee: NETPIA.COM, INC., Seoul (KR)

(21) Appl. No.: 11/816,683

(22) PCT Filed: Feb. 21, 2006
(86) PCT No.: PCT/KR2006/000589

§ 371 Date: Sep. 9, 2008

(30) Foreign Application Priority Data
Feb. 21, 2005 (KR) 10-2005-0013974
Mar. 31, 2005 (KR) 10-2005-0027412

(51) Int. Cl. G06F 17/30; G06F 21/00

(52) U.S. Cl. 726/23; 707/3; 707/E17.014

(57) ABSTRACT

Provided is a local domain name system for querying an external server for a client-requested domain name and providing desired data to a user. A determination is made as to whether a special policy is to be applied to a client-input query through a test task. When a special policy is to be applied to the query, the special policy is performed to provide additional service to the client.

### TECHNICAL FIELD

The present invention relates to a local domain name system, and more particularly, to a local domain name system and a method for providing service using the same which are capable of providing more stable and improved service by adding special (additional) functions to a conventional local domain name system.

### BACKGROUND ART

A domain name system (DNS) managing domain names on a network provides an IP (Internet Protocol) address so that a domain name according to an address system used on the Internet, is used in an IP layer.

For example, the domain name “www.kipo.go.kr” is used to access the Korean Intellectual Property Office (KIPO), but a corresponding numerical IP address such as “152.99.202.101” is required to actually access the KIPO system. The IP address corresponding to the domain name is provided according to a domain name system.

The domain name system has a hierarchical structure of an inverse-tree form. When a user inputs a domain name into a browser location window to query an IP address of the domain name, the query is sent to a local DNS server, and the local DNS server forwards the query to a root name server (root DNS server). The root name server returns to the local DNS server an IP address of a top-level domain (TLD e.g., .com and .kr) DNS server in response to the query. The local DNS server then resends the query message to TLD DNS server. The TLD DNS server responds with the IP address of authoritative DNS server for the query. Finally, the local DNS server resends the query message to the authoritative DNS server. The authoritative DNS server responds with the IP address of requested domain name.

The domain name system uses both User Datagram Protocol (UDP) and Transmission Control Protocol (TCP) as protocol. But the use of UDP is dominant because traffic is relatively small in UDP.

Meanwhile, a computer virus is a combination of instructions which modifies any computer program or its executable section and copies itself or its variant, which results in an adverse effect in operation of a computer. Computer viruses are copied and distributed as normal programs, infecting personal computers (PCs). Computer viruses propagate over networks as the Internet is widely used and most computers are connected to the networks. In particular, the viruses rapidly propagate over networks in the form of worm viruses that breed on their own as executable codes.

Further, programs are frequently linked to pop-ups or specific sites by commercially distributed malicious programs (e.g., adware and spyware) irrespective of user's intentions. With conventional virus prevention and therapy programs, such malicious programs can be removed to some extent, but it is difficult to prevent re-infection or propagation of an infected system, basically, in terms that the rapid development of a network environment expedites the infection.

Further, the infection of viruses or malicious programs may be prevented in advance by disposing a network equipment which removes the viruses and malicious programs on a network path over which the viruses or malicious programs propagate. It is, however, expensive.

Hereinafter, a conventional domain name system will be described. FIG. 1 is a block diagram of a typical conventional domain name system.

In a conventional domain name system, a local DNS server 10 forwards a query to a root name server A 11 in response to request of a client 8. The local DNS server 10 repeatedly queries the root name server A 11, the name server B 12, and the name server C 13 until it obtains IP address requested by the client. The root name server A 11, the name server B 12 and the name server C 13 are collectively referred to as an external server 15.

For example, when the client queries an IP address of www.abc.com, the local DNS 10 receives and sends the query of the client 8 to the root name server A 11. The local DNS 10 then receives an IP address of the name server B 12, which manages “.com” The local DNS 10 sends the query to name server B 12. The name server B 12 then provides an IP address of the name server C 13 managing the “abc.com” to the local DNS 10, and the local DNS 10 connects to the name server C 13 to obtain IP information of the “www.abc.com” and deliver it to the client.

However, a conventional domain name system has the following problems.

(1) Since the root name server A 11, the name server B 12, and the name server C 13 have a hierarchical structure, the local DNS 10 repeatedly resends queries to the servers when system or network failure occurs in one of the name servers. In addition, the re-queries cause server overloaded because UDP is used for communication. In the process, data that does not respond to a client's query is generally stored in the local DNS 10 because it is not known when the system or network is recovered. Accordingly, when an amount of non-responsive data increases, the local DNS 10 suffers from traffic overloaded, which degrades the quality of service.

In case that information of a root zone is erroneously established, a process such as normal query is repeatedly performed several times. Especially, in UDP, the system performs the process repeatedly, considering data loss problem. This causes a system overloaded. For these reasons, the Internet of Korea has been disabled in January, 2003.

(2) A domain name system according to the prior art resolves domain name in a hierarchical structure with a conventional policy. This makes it difficult for an operator of the domain name system to change the conventional policy and allow the domain name system to respond to a specific domain name with various manners.

(3) Most network programs use the domain name system for communication because of features of a network. Accordingly, the domain name system may be positively utilized to i) prevent clients from being infected by virus propagation and ii) to sense malicious programs or pop-up advertisements and eliminate them or prevent them from propagating over a network. However, scheme like that have not been suggested.

(4) When a name server is transferred or name server quits operating, it is preferable to notify users of this fact so they can change a setting to another name server. However, the users do not recognize which name server, which is part of an infrastructure, is being used.

(5) Even though the domain name system has a function of storing information about malicious program sites, blocking sites and the like in advance, and refusing service provision using the stored information, a manager needs to collect the information. It is difficult to collect the information. Accordingly, there is need for a method for solving this problem.

### DISCLOSURE OF INVENTION

### Technical Problem

It is an object of the present invention to provide a local domain name system and a method for providing service using the same which are capable of solving the afore-mentioned problems.

It is another object of the present invention to improve performance by reducing an overload on a domain name system and to enable a special policy to be reflected in a resolution process at a domain name system.

It is still another object of the present invention to provide a domain name system worm capable of eliminating viruses and malicious codes on a network.

It is yet another object of the present invention to enable a notice that a name server is transferred or further service is difficult to provide.

### Technical Solution

A first aspect of the present invention provides a local domain name system for querying an external server for a client-requested domain name and providing desired data to a user, the system comprising: a determining/policy performing unit for determining whether a special policy is to be applied to the query, providing the client with service for blocking access or enabling access to a specific website when a special policy is to be applied to the query, and delivering the query to a domain-IP resolution processor when a special policy is not to be applied to the query; and a domain-IP resolution processor connected to the determining/policy performing unit for receiving the query and resolving the domain name into a corresponding IP address to deliver the IP address to the user.

The “special policy” collectively refers to functions other than typical functions of the local domain name system. Preferred functions may include a drop cache function, a session filtering function, service provided upon inputting an unavailable domain name, malicious program blockage, notice of information to a DNS user, and a black list domain management function.

The determination as to whether a special policy is to be applied to the query may include both a pre-test task before a resolution task and an ex post test task after the resolution task. Preferably, the pre-test task may include a drop cache function, a session filtering function, malicious program blockage, and notice of information to a DNS user, and the ex post test task may include service provided upon inputting an unavailable domain name. However, the present invention is not limited to such a configuration.

A second aspect of the present invention provides a local domain name system for querying an external server for a client-requested domain name and providing desired data to a user, the system comprising: a database for storing IP addresses of clients that use the Internet; and a determining/policy performing unit connected to the database for classifying IP addresses of the clients into groups by referring to the database, allocating a predetermined time to each group, and enabling access to a specific webpage for the allocated time.

A third aspect of the present invention provides a local domain name system for querying an external server for a user-requested domain name and providing desired data to a user, the system comprising: a determining/policy performing unit for determining whether the user, input query includes domain name information about a unresponsive external server or a blocked site, and providing service for blocking access or enabling access to a specific website when the query includes the domain name information; and a domain-IP resolution processor connected to the determining/policy performing unit for receiving the query and resolving the domain name to a corresponding IP address using the external server when the query does not contain the information.

Preferably, the determining/policy performing unit may include an internal database in a circular queue form or be connected to an external database, and may set a pre-determined data storage criterion using data use frequency and reference time, and delete data that does not meet the criterion from the database.

A fourth aspect of the present invention provides a method for providing service using a local domain name system for querying an external server for a client-requested domain name and providing desired data to a user, the method comprising the steps of: when the client-requested query is input, determining whether a special policy is to be applied to the query; and providing the client with service for blocking access or enabling access to a specific website when a special policy is to be applied to the query, and discovering an IP address corresponding to the domain name and delivering the IP address to the client when a special policy is not to be applied to the query.

A fifth aspect of the present invention provides a method for providing service using a local domain name system for querying an external server for a client-requested domain name and providing desired data to a user, the method comprising the steps of: determining whether the user s input query includes domain name information about a unresponsive external server or information on a blocked site; and providing service for blocking access or enabling access to a specific website when it is determined that the query includes domain name information about a unresponsive external server or information on the blocked site, and receiving the query to resolve the domain name to a corresponding IP address using the external server when it is determined that the query does not include domain name information about a unresponsive external server or information on a blocked site.

### ADVANTAGEOUS EFFECTS

The present invention as described above has the following advantages:

(1) A system performance can be improved, and high quality of service can be maintained by intentionally terminating a query to an unresponsive server. In addition, propagation of viruses or malicious programs can be prevented by blocking a specific domain name or query format.

(2) A domain name system capable of providing more stable and improved service can be provided by reducing an unnecessary system load.

(3) System performance can be improved and a high quality of service can be maintained by preventing an entire system from being overloaded. In addition, propagation of viruses or malicious programs can be prevented by blocking a specific domain name or a specific query format through a special policy.

(4) When a name server is transferred or name server quits operating, a notice is provided to users. Since users are notified of the situation, they can change a setting to another name server.

(5) Malicious program sites can be blocked even when it is difficult for a domain name system to collect information about the malicious program sites, blocking sites and the like.

### BRIEF DESCRIPTION OF THE DRAWINGS

FIG. 1 illustrates the configuration of a conventional domain name system;

FIG. 2 illustrates the configuration of a domain name system according to an exemplary embodiment of the present invention;

FIG. 3 is a flowchart illustrating a method for providing service (drop cache) using a domain name system according to an exemplary embodiment of the present invention;

FIG. 4 is a flowchart illustrating a method for providing service (session filtering) using a domain name system according to an exemplary embodiment of the present invention;

FIG. 5 illustrates an example of a data format according to an exemplary embodiment of the present invention;

FIG. 6 is a flowchart illustrating a method for providing service (upon input of an unavailable domain name) using a domain name system according to an exemplary embodiment of the present invention; and

FIG. 7 is a flowchart illustrating a method for providing service (malicious program blockage) using a domain name system according to an exemplary embodiment of the present invention.

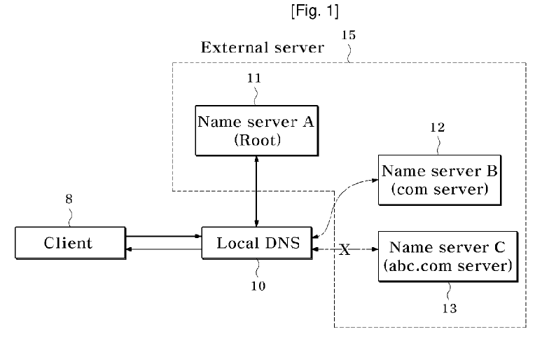

### MODE FOR THE INVENTION

Hereinafter, exemplary embodiments of the present invention will be described in detail. However, the present invention is not limited to the exemplary embodiments disclosed below, but can be implemented in various types. Therefore, the present exemplary embodiments are provided for complete disclosure of the present invention and to fully inform the scope of the present invention to those ordinarily skilled in the art.

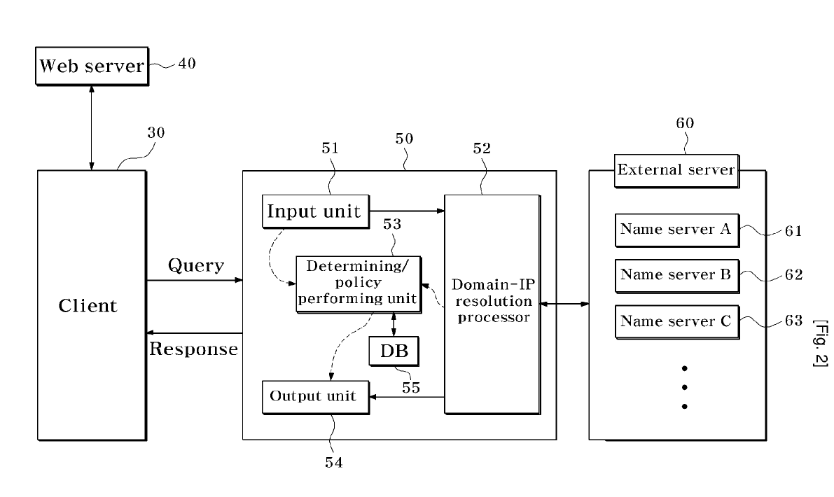

A domain name system according to an exemplary embodiment of the present invention will be described in detail with reference to FIG. 2. FIG. 2 illustrates the configuration of a domain name system according to an exemplary embodiment of the present invention.

Referring to FIG. 2, a local domain name system 50 is connected to a client 30 and an external server 60, and the client 30 is connected to a web server 40. The local domain name system 50 includes an input unit 51, a domain-IP resolution processor 52, a determining/policy performing unit 53, and an output unit 54. Meanwhile, the determining/policy performing unit 53 may serve as the input unit 51 and the output unit 54.

When a user input request of a specific domain name, the input unit 51 receives the request. The domain-IP resolution processor 52 resolves the requested domain name into a corresponding IP address using an internal cache or the external server. The external server 60 includes several name servers 61, 62, 63 . . . having a hierarchical structure to provide an IP address corresponding to the domain name by communicating with the local domain name system 50 through UDP.

The determining/policy performing unit 53 determines whether to apply a special policy to the user's query input though the input unit 51. If the query is to be applied with the special policy, the determining/policy performing unit 53 performs the special policy and then delivers the resultant to the client. Data in the database 55 are arranged to be easily retrieved in consideration of system performance. A binary search is used and consumes only a time of log n (n denotes the number of data), such that a value corresponding to specific data is retrieved quickly.

The determining/policy performing unit 53 stores an initial data storage time in order to reserve data in the database 55 for a predetermined time, and updates data use frequency and a reference time every time the data are used. The determining/policy performing unit 53 maintain a data storage space in the database 55, and deletes data to guarantee a response speed in consideration of the data use frequency and the reference time. Further, the determining/policy performing unit 53 establishes and processes a special policy to block a specific domain name or query format, thereby preventing propagation of viruses such as worm viruses and adware.

The output unit 54 notifies the user of an IP address of the domain name provided by the domain-IP resolution processor 52 or of a result produced by the changed policy in the determining/policy performing unit 53.

The above-described additional service of the local domain name system 50 can be implemented via software by applying an additional function to the Berkeley Internet Name Domain (BIND) of International Systems Consortium (ISC), Inc.

Meanwhile, special policies (additional services) that can be provided by the local domain name system 50 are as follows:

(1) The database 55 stores domain name information of a unresponsive external server, and the determining/policy performing unit 53 can notify the user that the service is correctly provided when it is determined that the input query is for the unresponsive external server (drop cache function).

(2) The database 55 stores an analysis result for a characteristic of each header content of a DNS for each malicious program, such as viruses, adware and the like, and the determining/policy performing unit 53 determines whether an IP address corresponding to the user-input query is filtered based on the analysis result when it requests the domain name system (session filtering function) for the IP address.

(3) When there is no IP address corresponding to the user-input query, the determining/policy performing unit 53 navigates a current webpage to a webpage providing a notice to the client (service provided upon inputting unavailable domain name) that the queried IP address cannot be located.

(4) The determining/policy performing unit 53 establishes and processes a special policy for blocking a specific domain name or query format to prevent propagation of viruses such as worm viruses and adware (malicious program blockage).

(5) The determining/policy performing unit 53 recognizes IP addresses of clients that use the Internet, stores the IP addresses in the database 55, classifies the IP addresses of the clients into groups, e.g., ten groups, allocates a predetermined time so that a specific webpage is accessed for the allocated time and a DNS user is notified of information related to DNS (information notice).

(6) The determining/policy performing unit 53 checks an amount of traffic for each IP address at uniform intervals, form a list of IP address for which an amount of traffic ranks in an upper level or is rapidly increasing, parses the site when an amount of traffic of the site exceeds a predetermined value, and recognizes that a great amount of traffic is due to a malicious program (domain name management of black list).

A special policy (additional service) that can be provided by above-described local domain name system 50 will now be described in detail.

(Drop Cache Function)

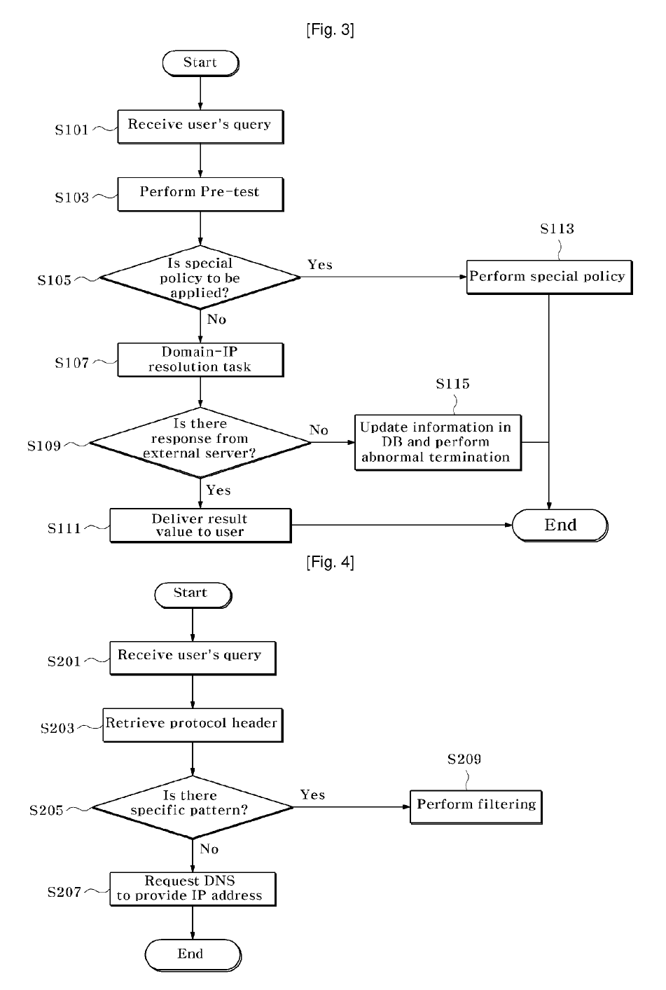

A drop cache function of a domain name system according to an exemplary embodiment of the present invention will be described in detail with reference to FIGS. 2 and 3. FIG. 3 is a flowchart illustrating a method for providing service (drop cache) using a domain name system according to an exemplary embodiment of the present invention.

In order to implement the drop cache function in the system of FIG. 2, the database 55 stores domain name information of a unresponsive external server, and the determining/policy performing unit 53 has a function of determining whether an input query is for the unresponsive external server by referring to the database 55.

Specifically, referring to FIGS. 2 and 3, when a user inputs a query to the input unit 51 of the local domain name system (S101), the determining/policy performing unit 53 performs a pre-test task by referring to the database 55 (S103), and checks whether to apply a special policy to the query based on a determination as to whether the query includes domain name information of the unresponsive external server 60 (S103). If it is determined that the special policy is to be applied, the determining/policy performing unit 53 performs the special policy, such as providing notice to the user through a website and site blockage (S113). If it is determined that the special policy is not to be applied, the determining/policy performing unit 53 performs resolution processing (resolves a domain name into a corresponding IP address) through the domain-IP resolution processor 52 (S107). Meanwhile, in the resolution task, it is checked whether there is a response from the external server (S109). If there is a response from the external server, the determining/policy performing unit 53 delivers an IP address to the user (S111) and ends the process.

If there is no response from the external server 60, the determining/policy performing unit 53 updates relevant data, number of usage, reference time, and the like in the internal database 55 and then performs abnormal termination (S115).

In particular, when the name server is for an Internet service provider (ISP), the query to the unresponsive external server degrades quality of service of the name server because an unspecified large number of users use the name server. The query to such a name server can be cached for a predetermined time and blocked in advance, thereby increasing the quality of service. Because such a function is applied to all queries, caching a number of domain names may lead to system performance degradation. Thus, it is desirable to limit a maximum storage amount. For example, the maximum storage amount may be 1024.

In this manner, when the local domain name system 50 delivers the user-requested query to the external server 60, and then the external server cannot respond in the resolution process, the local domain name system 50 stores relevant data in the database for a predetermined time and intelligently copes with a re-query when the user submits such a re-query to the unresponsive external server 60, thereby maintaining system performance and quality of service.

That is, when the user-requested query is for a domain corresponding to a service failure area, the local domain name system 50 (a name server program) recognizes and notifies the user that normal service cannot be provided. A BIND program, which is free name server software actually used by many users, does not provide such a function.

Meanwhile, various schemes, such as a scheme of maintaining system performance by regarding no domain name without performing a resolution task with an external server, and a scheme of notifying a user of related information through a prepared screen after a local domain name system delivers an IP address of any website, so that the user accesses the website, may be used to notify a user that normal service is impossible.

(Session Filtering Function)

A session filtering function of the domain name system according to an exemplary embodiment of the present invention will be described in detail with reference to FIGS. 2 and 4. FIG. 4 is a flowchart illustrating a method for providing service (session filtering) using a domain name system according to an exemplary embodiment of the present invention.

In the system of FIG. 2, the determining/policy performing unit 53 and the database 55 have their characteristic function to implement the session filtering function. The database 55 stores an analysis result for a characteristic of each header content of DNS data for each malicious program, such as viruses or adware. Session IP addresses, flags, and query types are defined in the header of the DNS data, and are parsed for processing. The determining/policy performing unit 53 determines whether to perform filtering based on the database 55 upon requesting the IP address corresponding to the user-input query to the domain name system.

Specifically, referring to FIGS. 2 and 4, when the user-requested query is input to the input unit 51 of the local domain name system (S201), the query is delivered to the external name server. Here, the determining/policy performing unit 53 retrieves a protocol header from the database 55 (S203) and checks whether there is a specific pattern corresponding to a specific virus (S205). If it is determined that there is a specific pattern, the determining/policy performing unit 53 filters a corresponding domain name (S209). If there is no specific pattern, the determining/policy performing unit 53 requests the DNS to provide an IP address (S207).

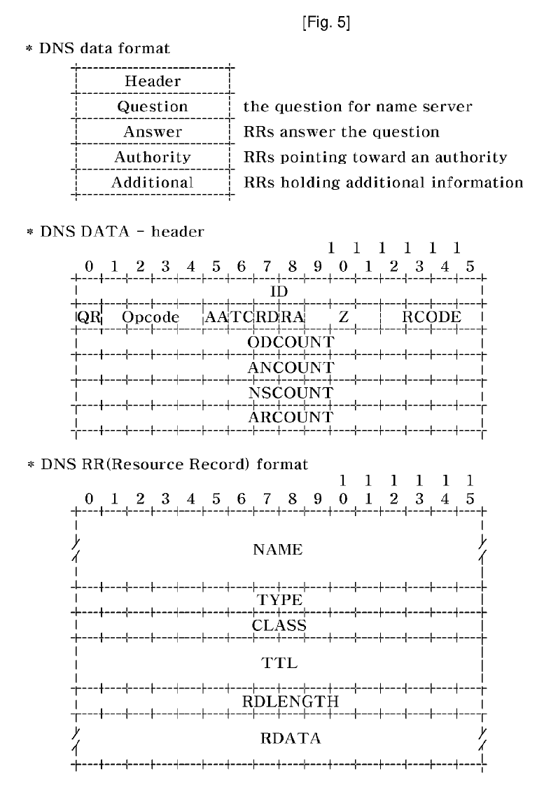

FIG. 5 shows an example of a data format. A description is given by way of example in connection with protocol (See RFC1035) that the local domain name system 50 according to an exemplary embodiment of the present invention uses to communicate between the server and the client. This protocol includes a header and four resource records (RRs).

Most malicious programs such as worm viruses and adware use a specific pattern. Accordingly, the local domain name system 50 discovers a specific value and stops the process to prevent propagation of the malicious programs in advance when the same domain name or query format is discovered. For example, the local domain name system 50 can prevent propagation of a program such as Win32.Bagle.U by using a 16-bit ID value in the header of the protocol.

To provide security to the domain name system, a scheme of determining whether to provide service based on an IP address is used. This scheme may be used to control service, but not when the IP address is ambiguous or not specific. In this case, a method of using filtering based on content of a header within the domain name system is useful.

For reference, “ID”, in the header format within the domain name system is a 16-bit identifier allocated by a program for generating any query. This identifier is copied into a response to the ongoing query (See FIG. 5).

A typical name server supports both user datagram protocol (UDP) and transmission control protocol (TCP). In UDP, high-speed processing is possible because there is no session connection, and a name server is less burdened. On the other hand, in TCP, a name server is burdened because operation is performed in a state where a session is connected. In particular, the name server is burdened with a heavy load when DNS is used to parse personal information of a personal computer (PC) infected with a specific virus or worm mail. Providing a function of filtering a TCP session querying the DNS with such a specific pattern can solve a problem of a heavy load on the name server.

(Service Provided Upon Inputting an Unavailable Domain Name)

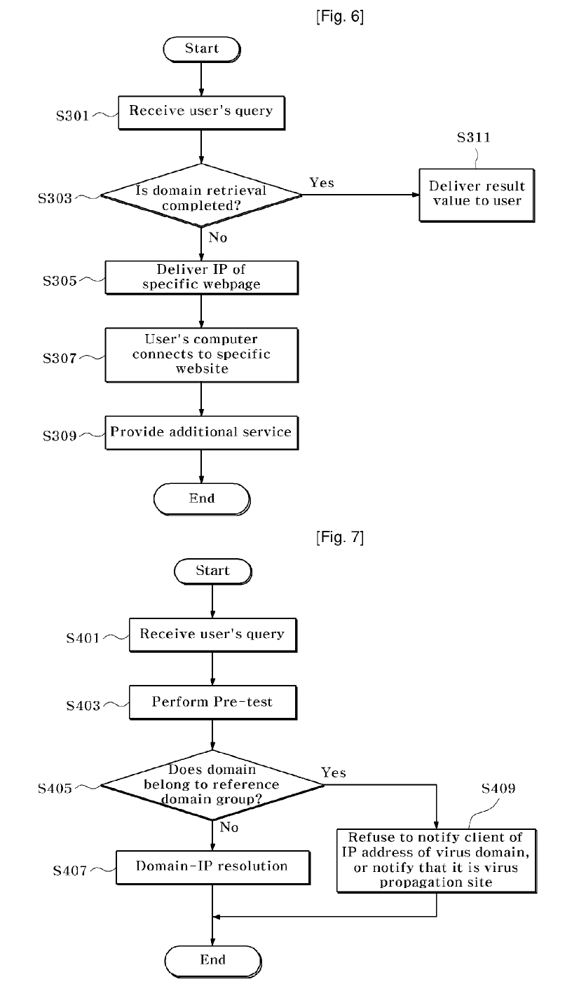

Service provided upon inputting an unavailable domain name using a specific webpage according to an exemplary embodiment of the present invention will now be described in detail with reference to FIGS. 2 and 6. FIG. 6 is a flowchart illustrating a method for providing service (upon inputting an unavailable domain name) using a domain name system according to an exemplary embodiment of the present invention.

Because, in this function, service is provided in a hierarchical structure, a name server responds with a result that it cannot discover a corresponding domain name when it does not discover the domain name. However, the use of a DNS operator's right enables such a domain name to be linked to a specific page in order to provide a detailed explanation to the user or perform marketing. In the system of FIG. 2, when there is no IP address corresponding to the user-input query, the determining/policy performing unit 53 delivers an IP address of a webpage capable of notifying the client 30 of this fact to the client, such that the client 30 navigates to the webpage.

Referring to FIG. 6, when a user-requested query is input to the input unit 51 of the local domain name system 50 (S301), it is delivered to the domain-IP resolution processor 52. The local domain name system 50 receives an IP address corresponding to the input query through the external server 60 connected to the domain-IP resolution processor 52. The determining/policy performing unit 53 then determines whether retrieval of domain name is completed (S303). For example, the determining/policy performing unit 53 determines whether retrieval of domain name is completed before the IP address is directly sent from the domain-IP resolution processor 52 to the client 30 via the output unit 54. If retrieval of domain name is completed, the determining/policy performing unit 53 delivers an IP address to the client 30 (S305).

If retrieval of domain name is not completed, the determining/policy performing unit 53 in this embodiment delivers a pre-promised IP address of a specific webpage to the client, unlike the conventional art in which an error message is sent. In response to receipt of the IP address, the client 30 connects to the specific website (S307) and receives additional service (S309).

The additional service may include providing content indicating that the client cannot be connected to a corresponding webpage due to non-existence of an IP address corresponding to the input query rather than network failure, by delivering an indication that there is no webpage corresponding to the user-input query such as URL, providing a list of WebPages corresponding to a query similar with the user input query, providing a notice enabling registration using a domain name corresponding to the user input query, and the like.

(Malicious Program Blockage)

A method of blocking a malicious program according to an exemplary embodiment of the present invention will now be described in detail with reference to FIGS. 2 and 7. FIG. 7 is a flowchart illustrating a method for providing service (malicious program blockage) using a domain name system according to an exemplary embodiment of the present invention.

The determining/policy performing unit 53 can prevent propagation of viruses such as worm viruses and adware by establishing and executing a special policy to block a specific domain name or query format. Domain names with virus are stored in a reference domain group within the database 55 connected to the determining/policy performing unit 53.

Accordingly, in the malicious program blocking method that can be provided by the local domain name system 50, when the client 30 queries the local domain name system 50 for an IP address of a specific domain name in order to access the Internet (S401), the local domain name system 50 performs a pre-resolution task in response to the user's query to check whether the domain name belongs to the reference domain group within the database 55 (S403 and S404). When a domain name corresponding to the user's query belongs to the reference domain group, the local domain name system 50 refuses to notify the client of the IP address of the domain name with virus or notifies the client that it is a virus propagation website (S409). Accordingly, the client 30 can recognize that the client-requested domain is a domain with virus and prevent virus propagation in advance.

However, when the user-requested domain does not belong to the reference domain group, the local domain name system 50 performs a normal resolution task to query the name server for the IP address of the domain name, receive the IP address from the name server, and provide the IP address to the client (S407).

Alternatively, domains with malicious program are collected and stored as a reference domain group in the database 55, such that the client 30 can connect to the web server 40 capable of curing the malicious programs. The web server 40 may have an anti-malicious program installed thereon.

Malicious programs generally operate for the purpose of exposing their site or webpage to users to advertise specific products or collect user information. Such malicious programs operate as specific scripts in a webpage or are directly installed in the client and operate according to a specific environment or condition.

Malicious programs cause inconvenience and damage by continuously providing unwanted information to users, obstructing access to intended information by changing functions, and illegally collecting user information. Such programs are installed in the client side without user permission or with no method of deleting them, which makes deleting them difficult. Users must eliminate such malicious programs with a specific program or manually.

More specifically, when the client 30 queries the local domain name system 50 for an IP address of a specific domain name in order to access the Internet, the local domain name system 50 checks whether the domain name belongs to the reference domain group stored in the database 55 while performing a pre-resolution task in response to the user's query.

If the domain name corresponding to the user's query belongs to the reference domain group, the local domain name system 50 responds with an IP address of the anti-malicious program web server 40 which provides a program capable of curing a malicious program. This enables the user not to access a malicious program site so that the malicious program does not operate, or to download a cure program in order to eliminate the malicious program.

If the user-requested domain name does not belong to the reference domain group, the local domain name system 50 performs the normal resolution task to query the name server for the IP address of the domain name and receive the IP address from the name server to notify the client of the IP address. The web server 40, which has an anti-malicious program distributing a program capable of curing malicious programs, is capable of performing HTTP processing and reporting.

(Information Notice to DNS User)

A method for notifying a DNS user of information according to an exemplary embodiment of the present invention will now be described in detail with reference to FIG. 2.

In the system of FIG. 2, the determining/policy performing unit 53 and the database 55 have particular functions to implement a function of notifying the DNS user of information. The determining/policy performing unit 53 recognizes IP addresses of clients 30 that use the Internet and stores the IP addresses in the database 55. In addition, the determining/policy performing unit 53 classifies the IP addresses of the clients 30 into for example ten groups so that the clients access a specific webpage for their allocated time.

When the user of the local domain name system 50 uses the Internet, this notice function may be implemented by linking a specific homepage other than a page corresponding to a user-input query. The local domain name system 50 and the web server 40 are utilized to provide the service. For example, since all the users have a unique IP address, IP addresses of the clients are classified into sub-groups so that the clients access a specific webpage for their allocated time.

Further, when the local domain name system 50 is transferred or further service is difficult to be provided, users do not recognize the used local domain name system 50, which is part of an infrastructure, until trouble occurs in the local domain name system 50. Accordingly, the user is notified of a situation such as server transfer so that the user recognizes the situation and changes his/her computer setting to another local domain name system. This notice function is developed to minimize disruption of service provided to the user. Users attempting to access the local domain name system 50 are notified of a specific guide page through service. It enables the users to respond with a specific IP address at uniform intervals.

Because the client 30 has its cache, most users can be notified by providing service for one week in 60 sec periods. When the notice term is short, the period may be shorter.

Meanwhile, the IP address of DNS server used by a user's computer is changed by distributing a program for modifying user's DNS setting on a homepage accessed via the local domain name system 50. This function is useful when the DNS operator cannot easily provide further DNS service or desires to change the IP address.

In an actual example, a domain name system operator can output desired page content by outputting notice of a homepage's content, not a non-homepage, in a specific time.

(Managing Blacklisted Domains)

A method for notifying a user of the local domain name system 50 of information according to an exemplary embodiment of the present invention will now be described in detail with reference to FIG. 2. The determining/policy performing unit 53 checks an amount of traffic of each IP address at uniform intervals to form a list of IP addresses for which an amount of traffic ranks in an upper level or is rapidly increasing. When an amount of traffic exceeds a predetermined value, the determining/policy performing unit 53 analyzes a relevant site to check whether an amount of traffic is caused by a malicious program.

Most local domain name systems have a function of managing domains capable of refusing service. However, such domains need to be collected and provided by a manager, and are difficult to collect. To overcome this inconvenience, domain names are classified into a black list and a white list for management, and other domain names for which an amount of traffic is rapidly increasing and ranks in an upper level are analyzed in real time and the analysis result is applied to the system.

Specifically, an amount of traffic is checked at uniform intervals whether a corresponding list is the black list or the white list. Even though a list for which an amount of traffic ranks in an upper level or is rapidly increasing is the white list, the site is analyzed. The site analysis is for checking whether the rapid traffic increase is caused by a specific virus, a malicious program, or the like. A troubled domain name is added to the black list. Otherwise, the domain name is re-checked or kept in the white list. When it is determined that the domain name is in the black list, it is written in the database and access to the domain name in the black list is blocked through pre-checking, as described above.

The local domain name system may include at least one special policy or additional service.

While the invention has been shown and described with reference to certain exemplary embodiments thereof, it will be understood by those skilled in the art that various changes in form and details may be made therein without departing from the spirit and scope of the invention as defined by the appended claims.

1. A local domain name system for querying an external server for a client-requested domain name and providing desired data to a user, the system comprising:
a determining/policy performing unit for determining whether a special policy is to be applied to the query, providing the client with service for blocking access or enabling access to a specific website when a special policy is to be applied to the query, and delivering the query to a domain-IP resolution processor when a special policy is not to be applied to the query; and
a domain-IP resolution processor connected to the determining/policy performing unit for receiving the query and resolving the domain name into a corresponding IP address to deliver the IP address to the user.

2. The system of claim 1, further comprising a database for storing domain name information of unresponsive external servers,
wherein the determination as to whether a special policy is to be applied to the query is made based on a determination as to whether the query requires access to the unresponsive external server by referring to the database.

3. The system of claim 1, further comprising a database for storing an analysis result for a characteristic of each header content of DNS data for each malicious program,
wherein the determination as to whether a special policy is to be applied to the query is made based on a determination as to whether the query belongs to the malicious program.

4. The system of claim 1, wherein the determination as to whether a special policy is to be applied to the query is made based on a determination as to whether there is an IP address corresponding to the user-input query, in which it is determined that a special policy is to be applied to the query when there is no IP address corresponding to the user-input query.

5. The system of claim 1, further comprising a database for storing domain name information for a specific domain or query format,
wherein the determination as to whether a special policy is to be applied to the query is made based on a determination as to whether the query includes domain information for a specific domain or query format by referring to the database.

6. The system of claim 1, wherein the determination as to whether a special policy is to be applied to the query is made by checking an amount of traffic for each domain name at uniform intervals to form a list of domains for which an amount of traffic ranks in an upper level or rapidly increases, and by determining whether each website in the list distributes a malicious program when an amount of traffic of the website exceeds a predetermined value.

7. The system of claim 1, wherein the determining/policy performing unit comprises an internal database in a circular queue form or is connected to an external database.

8. The system of claim 1, wherein the determining/policy performing unit sets a predetermined data storage criterion using data use frequency and reference time, stores the data storage criterion in a database, and deletes data that does not meet the criterion from the database.

9. A local domain name system for querying an external server for a client-requested domain name and providing desired data to a user, the system comprising:
a database for storing IP addresses of clients that use the Internet; and
a determining/policy performing unit connected to the database for classifying IP addresses of the clients into groups by referring to the database, allocating a pre-determined time to each group, and enabling access to a specific webpage for the allocated time.

10. A local domain name system for querying an external server for a user-requested domain name and providing desired data to a user, the system comprising:
a determining/policy performing unit for determining whether the user's input query includes domain name information about a unresponsive external server or a blocked site, and providing service for blocking access or enabling access to a specific website when the query includes the domain name information; and
a domain-IP resolution processor connected to the determining/policy performing unit for receiving the query and resolving the domain name to a corresponding IP address using the external server when the query does not contain the domain name information.

11. The system of claim 10, further comprising a database for storing an analysis result for a characteristic of each header content of DNS data for each malicious program,
wherein the determining/policy performing unit further determines whether the user's input query belongs to the malicious program.

12. A method for providing service using a local domain name system for querying an external server for a client-requested domain name and providing desired data to a user, the method comprising the steps of:
when the client-requested query is input, determining whether a special policy is to be applied to the query; and
providing the client with service for blocking access or enabling access to a specific website when a special policy is to be applied to the query, and discovering an IP address corresponding to the domain name to deliver the IP address to the client when a special policy is not to be applied to the query.

13. The method of claim 12, wherein the step of determining whether a special policy is to be applied to the query comprises the step of determining whether the query belongs to a malicious program by referring to a database which stores an analysis result for a characteristic of each header content of DNS data for each malicious program.

14. The method of claim 12, wherein the step of determining whether a special policy is to be applied to the query is made based on a determination as to whether there is an IP address corresponding to the user-input query, and when there is no IP address corresponding to the user-input query, a special policy is to be applied to the query.

15. A method for providing service using a local domain name system for querying an external server for a client-requested domain name and providing desired data to a user, the method comprising the steps of:
determining whether the user s input query includes domain information about a unresponsive external server or information on a blocked site; and
providing service for blocking access or enabling access to a specific website when it is determined that the query includes domain name information about a unresponsive external server or the blocked site, and receiving the query to resolve the domain name to a corresponding IP address using the external server when it is determined that the query does not include domain name information about a unresponsive external server or a blocked site.
